(19) United States
(12) Patent Application Publication
(10) Pub. No.: US 2010/0017511 A1
(43) Pub. Date: Jan. 21, 2010

(54) METHOD OF CONSTRUCTING TREE NETWORK

(75) Inventors: Yong-Sun Kim, Daejeon-city (KR); Se-Han Kim, Daejeon-city (KR); Jin-Kyeong Kim, Daejeon-city (KR); Nae-Soo Kim, Daejeon-city (KR); Cheol-Sig Pyo, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/443,369

(22) PCT Filed: Sep. 19, 2007
(86) PCT No.: PCT/KR2007/004559

§ 371 Date: Mar. 27, 2009

(30) Foreign Application Priority Data
Sep. 29, 2006 (KR) 10-2006-0096501

(51) Int. Cl. G06F 15/16

(52) U.S. Cl. 709/225; 709/252

(57) ABSTRACT

Provided is a method of constructing a tree network which includes a first node. The method comprises: (a) the first node determining if there is a child node and requesting a parent node to allow the first node to withdraw if there is no child node; (b) selecting a child node based on remaining amounts of battery power of each child node if there are child nodes of the first node; (c) exchanging positions of the first node and the selected child node and requesting the parent node to allow the first node to withdraw if the child node selected in operation (b) does not have child nodes; and (d) repeating operations (b) and (c) if the child node selected in operation (b) has child nodes. The present invention solves the problem of decreasing lifetimes of upper nodes that consume more battery power than lower nodes due to more traffic transmission and reception.

### CROSS-REFERENCE TO RELATED PATENT APPLICATIONS

This application claims the priority of Korean Patent Application No. 10-2006-0096501, filed on Sep. 29, 2006, in the Korean Intellectual Property Office, the disclosure of which is incorporated herein in its entirety by reference.

### BACKGROUND OF THE INVENTION

1. Field of the Invention

The present invention relates to a tree network, and more particularly, to a method of changing positions of nodes in a tree network in order to improve energy efficiency of the whole network by reducing network delays and network traffic which are inevitably produced due to frequent withdrawal of nodes from the network.

This work was supported by the IT R&D program of MIC/IITA[2007-S001-01, Development of Wearable Personal Station].

2. Description of the Related Art

In the conventional method, when a sensor node belonging to a sensor network having a tree structure withdraws from the network, child nodes connected to the sensor node should search the network to find a new parent, and this causes heavy network traffic. In particular, in the case of a binary network, the lower nodes undergo significant changes due to a middle positioned node withdrawing from the network. Moreover, if the node that withdraws from the network is located in the upper position of the tree network, the influence is more considerable.

When a battery is insufficient to supply power to a node, a similar problem may occur. In this case, the situation could be more severe than the case described above. In the above situation, the node which will withdraw from the network sends its parent node and child nodes a message that it will withdraw from the network so that the parent and child nodes can construct a new network. However, in this case, since the node is removed from the network unexpectedly, it may take the parent node and child nodes a long time to recognize the absence of the node and construct a new network. Nevertheless, if the node continuously self-checks the amount of power left in the battery and withdraws from the network when the remaining amount of power is below a threshold, the same scenario as the first case will happen.

### SUMMARY OF THE INVENTION

The present invention provides a method of changing positions of nodes based on the remaining amount of battery power of each node in order to considerably reduce network reconstruction overhead which may occur due to voluntary withdrawal of nodes in a tree sensor network or battery power consumption of the nodes.

According to an aspect of the present invention, there is provided a method of constructing a tree network which includes a first node, the method comprising: (a) the first node determining if there is a child node and requesting a parent node to allow the first node to withdraw if there is no child node; (b) selecting a child node based on remaining amounts of battery power of each child node if there are child nodes of the first node; (c) exchanging positions of the first node and the selected child node and requesting the parent node to allow the first node to withdraw if the child node selected in operation (b) does not have child nodes; and (d) repeating operations (b) and (c) if the child node selected in operation (b) has child nodes.

According to another aspect of the present invention, there is provided a method of constructing a tree network which includes a first node, the method comprising: (a) the first node selecting a child node that has the greatest remaining amount of battery power when a remaining amount of battery power of the first node is smaller than a threshold; (b) comparing a remaining amount of battery power of the selected node with the remaining amount of battery power of the first node and changing positions between the first node and the selected node when the remaining amount of battery power of the selected node is greater than the remaining amount of battery power of the first node; (c) repeating operations (a) and (b) if there are child nodes at the changed position; and (d) completing the network configuration at the current position if the changed position is the final position or a remaining amount of battery power of a child node is smaller than the remaining amount of battery power of the first node.

According to still another aspect of the present invention, there is provided a method of constructing a tree network which includes a first node, the method comprising: (a) selecting a child node that has the greatest remaining amount of battery power as a second node if a remaining amount of battery power of the first node is smaller than a threshold; (b) comparing the remaining amount of battery power of the first node with a remaining amount of battery power of the selected second node; (c) maintaining the current network structure if the remaining amount of battery power of the second node is smaller than the remaining amount of battery power of the first node; (d) repeating operations (a) through (c) using the second node if the remaining amount of battery power of the second node is greater than that of the first node; and (e) sending node information of a node to the first node which started comparing the remaining amounts of battery power and exchanging positions between the node and the first node if a remaining amount of battery power of a child node of the node is smaller than that of the node or the node does not have any child nodes.

According to yet another aspect of the present invention, there is provided a method of constructing a tree network which includes a first node, the method comprising: changing positions of an upper node and a lower node if a remaining amount of battery power of the first node is smaller than a first threshold; and changing a position of the previously changed node to withdraw from the network if the remaining amount of battery power of the node is smaller than a second threshold at the changed position.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart of procedures of a node which withdraws from a current tree network according to an embodiment of the present invention;

FIG. 2 illustrates an example for explaining in detail the method depicted in FIG. 1;

FIG. 3 is a flowchart of a method of constructing a network when a node belonging to the network has a smaller remaining amount of battery power than a predetermined threshold according to an embodiment of the present invention;

FIG. 4 illustrated an example for explaining in detail the method depicted in FIG. 3;

FIG. 5 is a flowchart of another method of constructing a network when a node belonging to the network has a smaller remaining amount of battery power than a predetermined threshold according to an embodiment of the present invention; and

FIG. 6 illustrates an example for explaining in detail the method depicted in FIG. 5.

### DETAILED DESCRIPTION OF THE INVENTION

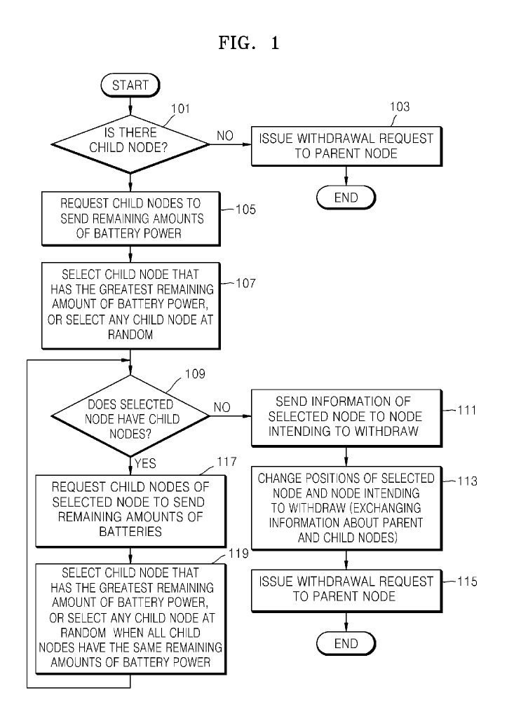

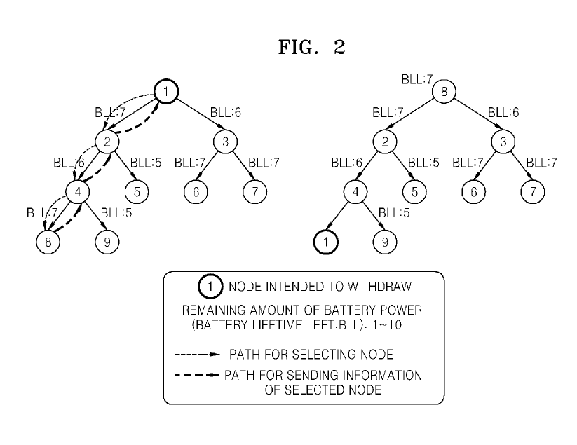

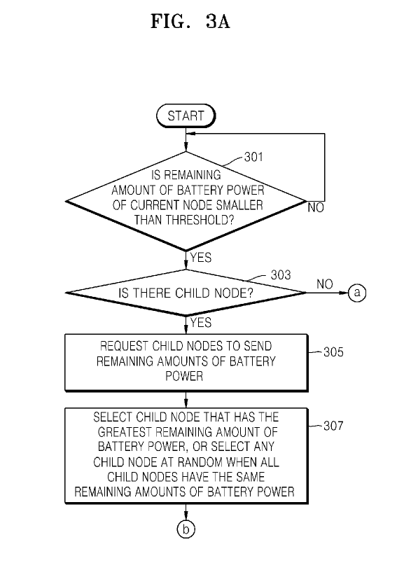

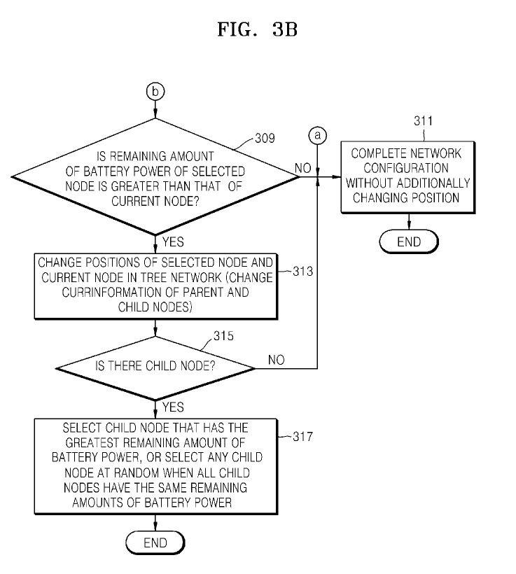

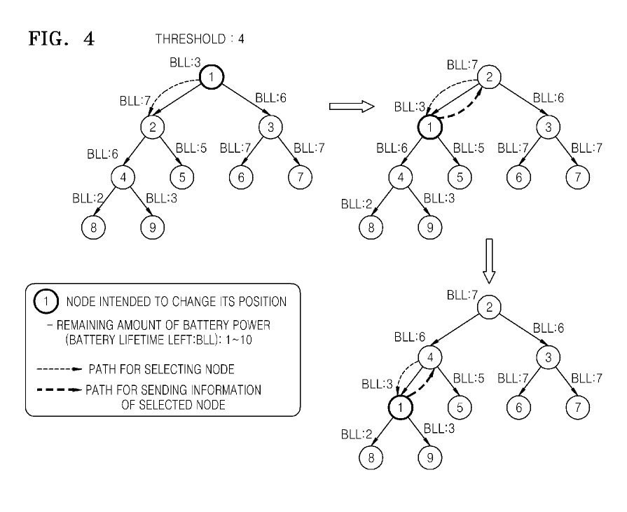

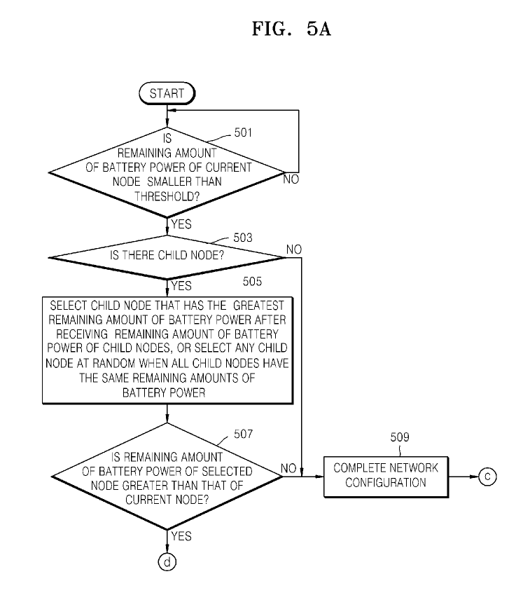

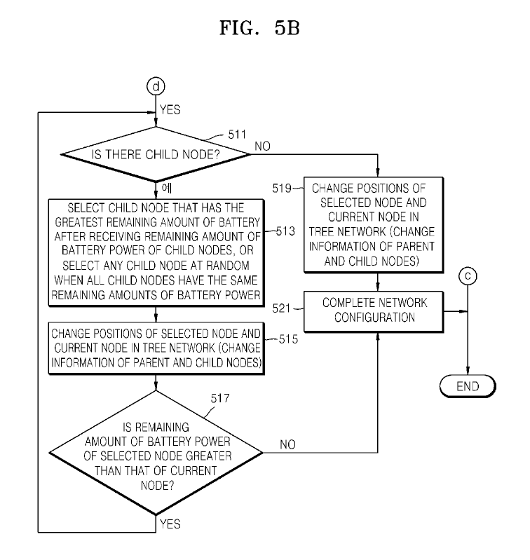

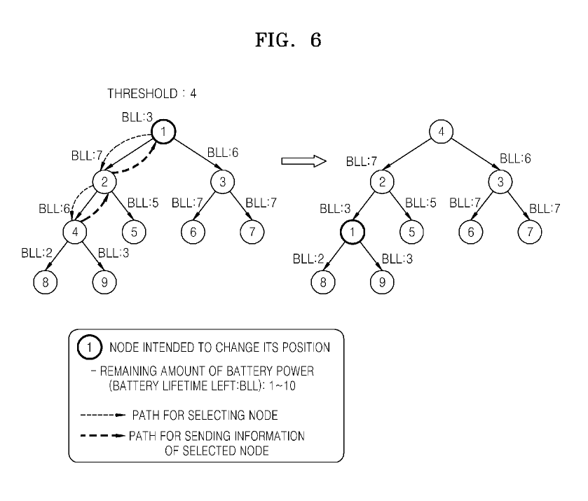

FIG. 1 is a flowchart of procedures of a node which withdraws from a current tree network according to an embodiment of the present invention, and FIG. 2 illustrates an example for explaining in detail the method depicted in FIG. 1. FIG. 3 is a flowchart of a method of constructing a network when a node belonging to the network has a smaller remaining amount of battery power than a predetermined threshold according to an embodiment of the present invention, and FIG. 4 illustrates an example for explaining in detail the method depicted in FIG. 3. FIG. 5 is a flowchart of another method of constructing a network when a node belonging to the network has a smaller remaining amount of battery power than a predetermined threshold according to an embodiment of the present invention, and FIG. 6 illustrates an example for explaining in detail the method depicted in FIG. 5.

The present invention is applied to two cases of a tree network—one for a case in which a node intends to withdraw from a current network and the other for a case in which a remaining amount of battery power of a node is lower than a predetermined threshold value. In the specification below it is assumed that a child node is chosen at random if the remaining amount of battery power of each child node are the same as one another.

Referring to FIG. 1, procedures of a case where a node belonging to a tree network intends to withdraw from the current network will be described. The node intending to withdraw from the network determines if there are child nodes (operation 101), and simply completes the procedures by requesting a parent node to let the node withdraw from the network if there is no child node, that is, the node is the final node (operation 103). However, if there are child nodes, the node requests the child nodes to inform the node of the remaining amount of battery power of each child node (operation 105). The node compares the remaining amounts of battery power of the child nodes and chooses a child node that has the greatest remaining amount of battery power, or selects a child node at random if the remaining amounts of battery power of the child nodes are the same (operation 107). According to whether the selected child node has its own child nodes (operation 109), if the selected node has the child nodes, the selected child node requests its child nodes to inform the selected node of their remaining amounts of battery power (operation 117), and then selects a child node that has the greatest remaining amount of battery power (operation 119). Then, the procedure returns to operation 109 and the procedures are repeated until there is no child node. If it is determined that there is no child node in operation 109, information including the remaining amount of battery power of the selected node is sent to the node which intends to withdraw from the network and from which the procedures are started (operation 111). Then, the positions of the node which intends to withdraw and the finally selected node are swapped (operation 113). Finally, the node that is supposed to omit issues a withdrawal request to the parent node (operation 115).

FIG. 2 illustrates an example for explaining how a first node follows the method illustrated in FIG. 1 when the first node is intended to withdraw from a network. The first node compares BLL (BLL) values of second and third nodes, which are child nodes of the first node. Referring to FIG. 2, since the BLL value of the second node is greater than that of the third node, the second node is chosen. If the BLL values of the child nodes are the same, a child node is chosen at random. Then the selected second node compares the BLL values of its child nodes. In FIG. 2, since a BLL value of a fourth node is greater than that of a fifth node, the fourth node is chosen. Then, the fourth node compares BLL values of eighth and ninth nodes, which are child nodes of the fourth node. In FIG. 2, the eighth node is selected. The eighth node has no child node and thus the eighth node is chosen as the final node. The eighth node informs the fourth node which is a parent node of the eighth node that it is the final node, the fourth node transmits this information to the second node, and the second node sends the information to the first node which intends to withdraw. The first node shifts its position to the position of the eighth node and exchanges information about child nodes and the parent node with the eighth node. Then the eighth node notifies the second and third nodes that the parent node is changed. After becoming a child node of the fourth node, the first node starts withdrawing from the network. The position of the node which intends to withdraw from the network is shifted to the position of the node located at the final end of the network, so that the nodes are moved the least and the packet overhead can be reduced.

The case in which a node belonging to a network happens to withdraw from a network unintentionally because a remaining amount of battery power of the node is lower than a predetermined threshold will be described below. An embodiment of the present invention can choose an algorithm depicted in either FIG. 3 or FIG. 5. Referring to FIG. 3, a first algorithm will be described. The node compares the remaining amount of its battery power with the predetermined threshold (operation 301). The threshold is predetermined by an administrator, depending on the circumstances of the network. When the remaining amount of battery power is greater than the threshold, this algorithm ends, but otherwise, it is checked if there are child nodes of the node (operation 303). If the child nodes are not present, the configuration of the network is completed without changing the positions of the nodes (operation 311) and the algorithm ends. However, if there are child nodes, the node requests the child nodes to inform about how much battery power of each child node is remaining (operation 305), receives the information about the amount of battery power, and then selects one that has the greatest remaining amount of battery power (operation 307).

The node compares the remaining amount of its battery power and the remaining amount of battery power of the selected node (operation 309), and completes the network configuration if its battery power amount is greater than the amount of battery power battery power of the selected node (operation 311). However, if the remaining amount of battery power of the selected node is greater than the remaining amount of battery power of the node, the position of the node is changed to the position of the selected node (operation 313). Then, the node whose position has changed to that of the selected node determines if there are child nodes (operation 315), and completes the network configuration if there are no child nodes. Otherwise, the node requests the child nodes to inform about how much battery power of each child node is remaining, and selects a child node that has the greatest remaining amount of battery power, or selects any node at random if the remaining amount of battery power of every child node is the same (operation 317). Then, the procedures return to operation 309 and repeat the operations thereafter.

FIG. 4 illustrates an example to which the algorithm depicted in FIG. 3 is applied when a first node has a smaller remaining amount of battery power than a predetermined threshold and thus a structure of a network is changed. Referring to FIG. 4, since the BLL value of the first node is 3 and the threshold is 4, the first node requests second and third nodes, which are child nodes of the first node, to inform about their BLL values. In FIG. 4, the BLL value of the second node is greater than that of the third node, and thus the second node is selected. If the BLL values of the child nodes are the same, one of child nodes is selected at random. Then, the BLL value of the second node is compared with that of the first node. Since the BLL value of the second node is greater than that of the first node, the positions of the first and the second nodes are swapped. At this time, the information about the child nodes and a parent node are exchanged between the first and second nodes. Afterwards, the first node requests a fourth and a fifth nodes, which are child nodes of the first node, to inform what their BLL values are, chooses a bigger value and then compares its BLL value with the chosen value. In FIG. 4, the fourth node is chosen, and since the BLL value of the fourth node is greater than that of the first node, the positions of the first and the fourth nodes are exchanged. Then, the first node requests eighth and ninth nodes, which are child nodes of the first node, to inform about their BLL values. Since the BLL value of the ninth node is smaller than that of the first node, there is no position shift and the network configuration is completed.

Referring to FIG. 5, a second algorithm will be described. A node compares a remaining amount of its battery power to a predetermined threshold (operation 501). The threshold is predetermined by an administrator, depending on the circumstances of the network. After the comparison, if the amount of battery power of the node is greater than the threshold, the network remains unchanged. Otherwise, it is checked if there is a child node of the node (operation 503). If there are child nodes, the node requests the child nodes to inform about how much battery power of each child node remains, and then selects a child node that has the greatest remaining amount of battery power (operation 505). The node compares the remaining amount of its battery power with the remaining amount of battery power of the selected child node (operation 507), and completes the network configuration if the amount of battery power of the node is greater than the amount of battery power of the selected child node (operation 509). However, if the remaining amount of battery power of the node is smaller than the amount of battery power of the selected child node, the node checks if there is a child node of the selected child node (operation 511). If the selected child node does not have any child nodes, the node changes position with the selected child node (operation 519) and then the network configuration is complete (operation 521). However, in operation 511, if there are child nodes, each of the child nodes is requested to inform about how much battery power remains, and then the corresponding node selects a child node that has the greatest remaining amount of battery power (operation 513), and then shifts its position to the position of the selected child node in the tree network (operation 515). Then the remaining amount of battery power of the node is compared with the remaining amount of battery power of the selected node. If the remaining amount of battery power of the selected node is smaller than the remaining amount of battery power of the node, the network configuration is completed (operation 521), but otherwise, the procedures return to operation 311 and repeats the operations thereafter.

A specific example of the algorithm depicted in FIG. 5 will be described with reference to FIG. 6. A BLL value of a first node is 3, and a threshold is 4. The first node requests second and third nodes, which are child nodes of the first node, to inform about their BLL values are. In FIG. 6, since the BLL value of the second node is greater than that of the third node, the second node is selected. When the BLL values of child nodes are the same, any child node is selected at random. Then the BLL value of the selected second node is compared to the BLL value of the first node. Referring to FIG. 6, since the BLL value of the second node is greater than that of the first node, the second node is selected. Then the second node requests fourth and fifth nodes, which are child nodes of the second node, to inform about their BLL values, receives the values from the fourth and fifth nodes, and selects the bigger value. Then, the selected value is compared with the BLL value of the first node. In FIG. 6, the fourth node is selected, and since the BLL value of the fourth node is greater than that of the first node, the above procedures are repeated. Finally, the fourth node requests eighth and ninth nodes, which are child nodes of the fourth node, to inform about their BLL values. In FIG. 6, since the BLL value of the selected ninth node is not greater than the BLL value of the first node, the procedures are not repeated. Then, the network configuration is completed by changing the positions between the first and fourth nodes without exchanging node information about the child nodes and a parent node.

An embodiment of the present invention may use two different thresholds at different steps to compare remaining amounts of battery power of nodes. A tree network is reconstructed by changing a position of a node from an upper position to a lower position when a remaining amount of battery power of the node is smaller than a first threshold, and when the remaining amount of battery power is smaller than a second threshold, the position of the node is changed to allow the node to withdraw. That is, when the remaining amount of battery power of the node is smaller than the first threshold, operations illustrated in FIG. 3 or FIG. 5 are performed, and when the remaining amount of battery power is smaller than the second threshold, operations illustrated in FIG. 1 are performed. By doing this, the lifetime of each node become almost equal to the average value of the whole node's lifetime and the network reliability is not affected substantially even when a node withdraws from a network unexpectedly due to a shortage of battery power.

As described above, a method of constructing a tree network according to the present invention can considerably reduce a network reconfiguration overhead which might be caused by the voluntary withdrawal of nodes from a network or consumption of battery power. Moreover, upper nodes, which consume more battery power, are moved to lower positions, and thus the differences between nodes' lifetimes can be reduced, which leads to an increase in the lifetime of the whole network.

According to the present invention, two different thresholds may be used in two steps to compare remaining amounts of battery power of nodes belonging to a network. If a remaining amount of battery power of a node is smaller than a first threshold, the node is moved to a lower position to reconstruct a tree network, and then if the battery remaining amount is smaller than a second threshold, the position of the node is changed to make the node withdraw from the network. By doing this, the lifetimes of nodes can be equal and the network reliability is not affected substantially even when a node withdraws from a network unexpectedly due to a shortage of battery power.

In conclusion, the present invention solves the problem of decreasing lifetimes of upper nodes that consume more battery power than lower nodes due to more traffic transmission and reception. That is, the lifetimes of the nodes belonging to the network are almost equal, and thereby reducing the withdrawal of upper nodes from the network due to the battery power shortage and substantially decreasing the network traffic.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of constructing a tree network which includes a first node, the method comprising:
(a) the first node determining if there is a child node and requesting a parent node to allow the first node to withdraw if there is no child node;
(b) selecting a child node based on remaining amounts of battery power of each child node if there are child nodes of the first node;
(c) exchanging positions of the first node and the selected child node and requesting the parent node to allow the first node to withdraw if the child node selected in operation (b) does not have child nodes; and
(d) repeating operations (b) and (c) if the child node selected in operation (b) has child nodes.

2. The method of claim 1, wherein operation (b) selects the child node that has the greatest remaining amount of battery power, or selects any child node at random if the remaining amounts of battery power of the child nodes are the same.

3. A method of constructing a tree network which includes a first node, the method comprising:
(a) the first node selecting a child node that has the greatest remaining amount of battery power when a remaining amount of battery power of the first node is smaller than a threshold;
(b) comparing a remaining amount of battery power of the selected node with the remaining amount of battery power of the first node and changing positions between the first node and the selected node when the remaining amount of battery power of the selected node is greater than the remaining amount of battery power of the first node;
(c) repeating operations (a) and (b) if there are child nodes at the changed position; and
(d) completing the network configuration at the current position if the changed position is the final position or a remaining amount of battery power of a child node is smaller than the remaining amount of battery power of the first node.

4. The method of claim 3, wherein operation (a) includes:
(a1) determining whether the remaining amount of battery power of the first node is smaller than a first threshold;
(a2) staying at the current position if the remaining amount of battery power of the first node is greater than the first threshold, or otherwise determining whether there are child nodes of the first node; and
(a3) requesting the remaining amounts of battery power of child nodes and selecting a child node that has the greatest remaining amount of battery power if the first node has the child nodes.

5. The method of claim 4, wherein operation (a3) includes selecting any child node at random if the remaining amounts of battery power of the child nodes are the same.

6. A method of constructing a tree network which includes a first node, the method comprising:
(a) selecting a child node that has the greatest remaining amount of battery power as a second node if a remaining amount of battery power of the first node is smaller than a threshold;
(b) comparing the remaining amount of battery power of the first node with a remaining amount of battery power of the selected second node;
(c) maintaining the current network structure if the remaining amount of battery power of the second node is smaller than the remaining amount of battery power of the first node;
(d) repeating operations (a) through (c) using the second node if the remaining amount of battery power of the second node is greater than that of the first node; and
(e) sending node information of a node to the first node which started comparing the remaining amounts of battery power and exchanging positions between the node and the first node if a remaining amount of battery power of a child node of the node is smaller than that of the node or the node does not have any child nodes.

7. The method of claim 6, wherein operation (a) includes selecting any child node at random if the remaining amounts of battery power of the child nodes are the same.

8. A method of constructing a tree network which includes a first node, the method comprising:
(a) changing positions of an upper node and a lower node if a remaining amount of battery power of the first node is smaller than a first threshold; and
(b) changing a position of the previously changed node to withdraw from the network if the remaining amount of battery power of the node is smaller than a second threshold at the changed position.

9. The method of claim 8, wherein operation (a) includes:
(a1) selecting a child node that has the greatest remaining amount of battery power when the remaining amount of battery power of the first node is smaller than the first threshold;
(a2) changing the positions of the selected node and the first node when a remaining amount of battery power of the selected node is greater than that of the first node;
(a3) repeating the operations (a1) and (a2) when the first node has child nodes at the changed position; and
(a4) completing the network configuration at the current position if the changed position is the final position or a remaining amount of battery power of a child node is smaller than the remaining amount of battery power of the first node.

10. The method of claim 9, wherein the operation (a1) includes:
(a11) determining whether the remaining amount of battery power of the first node is smaller than the first threshold;
(a12) staying at the current position when the remaining amount is greater than the first threshold, or otherwise, determining whether there are child nodes; and
(a13) requesting the remaining amounts of battery power of child nodes and selecting a child node that has the greatest remaining amount of battery power if there are child nodes.

11. The method of claim 8, wherein operation (a) further includes:
(a5) selecting a child node that has the greatest remaining amount of battery power as a second node when the first node has the smaller remaining amount of battery power compared to the first threshold;
(a6) comparing the remaining amount of battery power of the selected node to the remaining amount of battery power of the first node;
(a7) maintaining the current network structure if the remaining amount of battery power of the second node is smaller than the remaining amount of battery power of the first node;
(a8) repeating operations (a5) through (a7) using the second node if the remaining amount of battery power of the second node is greater than that of the first node; and
(a9) sending node information of a node to the first node which started comparing the remaining amounts of battery power and exchanging positions between the node and the first node if a remaining amount of battery power of a child node of the node is smaller than that of the node or the node does not have any child nodes.

12. The method of claim 8, wherein operation (b) includes:
(b1) the first node determining if there is a child node and requesting a parent node to allow the first node to withdraw if there is no child node;
(b2) selecting a child node based on remaining amounts of battery power of each child node if there are child nodes of the first node;
(b3) exchanging positions of the first node and the selected child node and requesting the parent node to allow the first node to withdraw if the child node selected in operation (b2) does not have child nodes;
(b4) repeating operations (b2) and (b3) if the child node selected in operation (b2) has child nodes.

13. A computer readable recording medium having embodied thereon a computer program for executing a method of constructing a tree network which includes a first node, the method comprising:
(a) the first node determining if there is a child node and requesting a parent node to allow the first node to withdraw if there is no child node;
(b) selecting a child node based on remaining amounts of battery power of each child node if there are child nodes of the first node;
(c) exchanging positions of the first node and the selected child node and requesting the parent node to allow the first node to withdraw if the child node selected in operation (b) does not have child nodes; and
(d) repeating operations (b) and (c) if the child node selected in operation (b) has child nodes.

14. A computer readable recording medium having embodied thereon a computer program for executing a method of constructing a tree network which includes a first node, the method comprising:
(a) the first node selecting a child node that has the greatest remaining amount of battery power when a remaining amount of battery power of the first node is smaller than a threshold;
(b) comparing a remaining amount of battery power of the selected node with the remaining amount of battery power of the first node and changing positions between the first node and the selected node when the remaining amount of battery power of the selected node is greater than the remaining amount of battery power of the first node;
(c) repeating operations (a) and (b) if there are child nodes at the changed position; and
(d) completing the network configuration at the current position if the changed position is the final position or a remaining amount of battery power of a child node is smaller than the remaining amount of battery power of the first node.

15. A computer readable recording medium having embodied thereon a computer program for executing a method of constructing a tree network which includes a first node, the method comprising:
(a) selecting a child node that has the greatest remaining amount of battery power as a second node if a remaining amount of battery power of the first node is smaller than a threshold;
(b) comparing the remaining amount of battery power of the first node with a remaining amount of battery power of the selected second node;
(c) maintaining the current network structure if the remaining amount of battery power of the second node is smaller than the remaining amount of battery power of the first node;
(d) repeating operations (a) through (c) using the second node if the remaining amount of battery power of the second node is greater than that of the first node; and
(e) sending node information of a node to the first node which started comparing the remaining amounts of the battery power and exchanging positions between the node and the first node if a remaining amount of battery power of a child node of the node is smaller than that of the node or the node does not have any child nodes.

16. A computer readable recording medium having embodied thereon a computer program for executing a method of constructing a tree network which includes a first node, the method comprising:
(a) changing positions of an upper node and a lower node if a remaining amount of battery power of the first node is smaller than a first threshold; and
(b) changing a position of the previously changed node to withdraw from the network if the remaining amount of battery power of the node is smaller than a second threshold at the changed position.
